(19) United States
(12) Patent Application Publication
(10) Pub. No.: US 2005/0279093 A1
(43) Pub. Date: Dec. 22, 2005

(54) Supercharged intercooled engine using turbo-cool principle and method for operating the same

(76) Inventors: Lin-Shu Wang, Stony Brook, NY (US); Shiyou Yang, Stony Brook, NY (US)

Correspondence Address: DILWORTH & BARRESE, LLP, 333 EARLE OVINGTON BLVD., UNIONDALE, NY, 11553, US

(21) Appl. No.: 11/155,862

(22) Filed: Jun. 16, 2005

Related U.S. Application Data
(60) Provisional application No. 60/590,100, filed on Jul. 22, 2004.
(60) Provisional application No. 60/580,493, filed on Jun. 17, 2004.

(51) Int. Cl. F02B 29/04; F02B 33/44; F02D 23/00

(52) U.S. Cl. 60/599; 60/600

(57) ABSTRACT

A supercharged and intercooled engine utilizing the turbo-cool principle and a method for operating the same is provided. The classical Carnot-Otto-Diesel paradigm for internal combustion engines is modified so internal combustion engines achieve highest performance in an optimal peak temperature range, which is lower than the typical peak operation temperatures of current gasoline engines and diesel engines. Turbo-cooling turbocharging systems provide for internal combustion engines operating within this peak temperature range by simultaneously controlling engine load-and-speed and intake-air temperature through the combined application of a primary load-and-speed control and a second operation control unit, primarily for intake air conditioning. This can be applied to gasoline engines, diesel engines, direct-injection gasoline engines, and homogeneous charge compression ignition (HCCI) engines.

### PRIORITY

This application claims priority to a provisional application entitled “Turbo-Cool: The Turbo-Cooling Principle of Internal-Combustion Engines” filed in the US Patent Office on Jul. 22, 2004 and assigned U.S. patent application Ser. No. 60/590,100 and to a provisional application entitled “The Turbo-Cooling Principle of Internal Combustion Engines” filed in the US Patent Office on Jun. 17, 2004 and assigned U.S. Pat. No. 60/580,493.

### BACKGROUND OF THE INVENTION

1. Field of the Invention

The present invention relates generally to supercharged internal combustion engines. Specifically, the present invention is directed to a turbocharged-intercooled engine, which may be a homogeneous charge spark ignition (SI) type, a heterogeneous charge compression ignition (diesel) type, a heterogeneous charge (direct-injection) spark ignition type, or homogeneous charge compression ignition (HCCI) type.

2. Description of the Related Art

H. R. Ricardo stated, “The piston engine is eminently suitable to deal with relatively small volumes at high pressure and temperature and the turbine, by virtue of its high mechanical efficiency and large flow areas, to deal with large volumes at low pressures. Clearly, the logical development is to combine the two in series to form a compound unit.” (Smith 1955: 279-280). He envisaged the possibility of an engineering system, not as a modification of the piston engine, but as a new rational whole with the compelling logic of resulting mechanical (gas exchanging) advantage and thermodynamic advantage.

Existing turbocharged engines, both diesel engines and SI gasoline engines, apply turbo-charging by modifying naturally-aspirated piston engines. They produce the desired power boosting as expected. However, the power boosting in the case of SI gasoline engines is curtailed by knock limits, and, in the case of diesel engines, by mechanical and thermal load limits. Furthermore, the efficiency of turbocharged SI engines suffers as a result of measures that are necessary for knock avoidance.

Engine operating pressure and temperature approach these limits at high speed and torque load, as a result of excessive energy in the exhaust charge under these operating conditions. In the case of gasoline engines operating under these operating conditions, waste-gates are pressure-activated (pneumatically) according to a set intake-manifold pressure limit to bypass the excess exhaust charge from a turbocharger turbine in order to prevent engines from exceeding the knock limit. In the case of diesels, both waste-gate and fuel rate control are used to safeguard engines from exceeding the mechanical and thermal load limits.

A pressure-relief valve on the intake side of the engine has been used as an alternative to a waste-gate. A further refinement of the pressure-relief valve concept was presented in U.S. Pat. No. 6,158,217 (Wang). The new solution, using an apparatus referred to in Wang as a cryo-cooler unit, does more than absorb the excess charge-exhaust energy. It utilizes the excess charge-exhaust energy at high speed and high load operation to supply the compressed charge-air to the engine intake manifold at desired low temperatures. The delivery of the compressed charge-air to the engine intake manifold at low temperatures represents a better solution to matching a turbocharger with a piston-engine than the forced matching of a piston-engine turbocharger system operating with a waste-gate. However, the solution based on the cryo-cooler is conceived as a refinement to the relief valve, pressure-activated at the narrow range of high speed and torque load. According to Wang, during low speed/load operation the bypass valve opens to one path alone and directs all compressed and intercooled air to the intake manifold. During high speed/load operation, when exhaust charge with excessive enthalpy is available to drive the turbine, the bypass valve opens to both paths. The ability of such a cooler to provide intake charge of low temperature hints at a possibility that this cooler may be used as a part of engine system operation under a broad range of speeds and loads, providing the internal-combustion engine with charge-air at a preferred temperature.

The classical idea (the Carnot-Otto-Diesel paradigm) that the theoretical thermal efficiency of combustion engines increases with the engine operating temperature monotonically is rejected by two recent developments: (1) a paper, “Reflections On Heat Engines: The Operational Analysis Of Isothermal Combustion,” AES-Vol. 27/HTD-Vol. 228, Thermodynamics and the Design, Analysis, and Improvement of Energy Systems, pp. 315-327, ASME (1992); and (2) a promising engine technology, which uses a new combustion process, homogeneous charge compression ignition, leading to low temperature spontaneous flameless combustion. Both, the theoretical and the other real technology development, demonstrate that combustion engine performance improves with engine operating temperature up to a point. Once that peak-temperature point is reached, engine operation is optimized by keeping operating temperatures from exceeding that peak-temperature range.

The compelling logic in mechanical and thermodynamic advantages that Ricardo hinted at should be modified as follows. While high intake charge pressure due to turbocharging brings about high power output, this increase in high intake charge pressure should be accompanied with an optimal intake charge temperature, which is not necessarily a monotonic function of pressure. In fact, the optimal intake charge temperature may change in an opposite direction to pressure, once the engine operating temperature reaches the peak-temperature range.

### SUMMARY OF THE INVENTION

Accordingly, the present invention is made to solve the above-mentioned problems and limitations in the prior art. The present invention provides a supercharged intercooled engine utilizing the turbo-cool principle and methods for operating the same. It is an object of the invention to provide for the simultaneous controlling of both load and speed control and conditioning of intake air in such engines so as to provide superior engine operation. It is a further object of the invention to provide a first operation control unit primarily for speed control, a second operation control unit primarily for conditioning intake air, and an operation control means for controlling a start-of-combustion. It is another object of this invention to provide a method for operating an internal combustion engine including the steps of simultaneously controlling load-and-speed and condition of intake air temperature through the combined application of a first operation control unit, primarily for load-and-speed control, and a second operational control unit, primarily for intake air conditioning. It is also an object of this invention to provide an engine management method for optimally controlling engine operation through the use of an engine management mapping-algorithm.

The present invention is applicable to both spark ignition and diesel engine types and therefore has multiple embodiments to recognize the different methods of engine load controls unique to the engine type and which will not be changed by the present invention. The spark-ignition (SI) engine load is controlled by changing intake-manifold pressure (thus, charge-air mass flow) brought about through varying the throttle-butterfly opening. The intake air of diesel engines is not throttled; the fuel quantity (fuel rate) alone is used for the diesel engine's load control. The direct-injection SI engine load control is similar to the diesel engine during its heterogeneous-charge operation mode and similar to the SI engine during its homogeneous-charge operation mode.

The present invention, turbo-cool, introduces a new application of the cryo-cooler, which was itself a refinement of the pressure relief valve concept as a replacement of the waste-gate. The cryo-cooler was conceived to operate under load/speed conditions that would have necessitated waste-gate operation and its operation leads to low temperature intake air. The turbo-cooling principle integrates this temperature lowering function of the cryo-cooler with the temperature regulation function. An actively controlled flow-control-valve controls engine operation under broad loads and speeds. In the prior art, the “cryo-cooler” served as means of handling excess charge exhaust energy with a passively controlled relief valve, pressure-activated under high speed/load operation only. In acknowledging its new application as an active temperature regulation, the cryo-cooler is hereinafter referred to as a turbo-cooler and the flow-control-valve is hereby referred to as a turbo-cooler valve.

The present invention employs a first operation control unit to primarily address load/speed control and a secondary control unit to address conditioning intake air temperature. The active control-use of turbo-cooler valve towards engine operation control operates in the following way: the turbo-cooler, primarily for conditioning intake air temperature, is used in combination with a primary load/speed control to simultaneously control engine load/speed and intake air temperature at optimal values over a broad range of loads and speeds.

The optimum setting of turbo-cooler valve for each given throttle butterfly setting in the SI engine model is determined by testing. Correspondingly, the optimum setting of turbo-cooler valve for each given fuel rate setting in the diesel engine is also determined by testing. The combined application of the primary load/speed control and the primary intake air temperature control allows the engine of the present invention to operate at each steady-state speed and load with intake air in a “sweet spot” of charge-air temperature and pressure, producing unsurpassed performance in thermal efficiency and power.

Significant gains in both thermal efficiency and power density (extraordinary gain in the case of SI engines) of the proposed engine technology form a powerful combination with superior synergistic potential in fuel economy improvement for automotive use, producing unsurpassed performance at reasonable cost.

The capability to simultaneously control engine load/speed and intake air temperature at optimal values over a broad range of loads and speeds has an additional application. One of the most promising engine technologies that has emerged over the past few years is called the homogeneous charge compression ignition (HCCI) engine. The combustion process for the HCCI engine is fundamentally different from SI or diesel combustion in the form of spontaneous flameless combustion. The low temperature spontaneous flameless combustion produces very low NOx and particulate matter (PM) emissions combined with high, diesel-like efficiency under ideal conditions. This combination of low emissions and high efficiency explains the excitement generated by the prospect of HCCI.

Currently, the promise and the excitement are tempered only by the considerable challenges HCCI faces. The most crucial ones among them is the control of the start-of-combustion (SOC) due to the “spontaneous” nature of combustion-ignition. Methods, such as exhaust gas recirculation (EGR) and ignition-assistance, are available for promoting HCCI ignition (making SOC earlier) at low engine loads. It is more difficult to delay HCCI ignition (which becomes necessary at middle and high engine loads under turbocharging conditions) to produce ideal HCCI combustion at high loads. Methods, including conditioning of the intake charge that are used in laboratory experiments for controlling SOC, are impractical for mobile applications. Turbo-cool is a technology for conditioning of intake charge for mobile applications, and is ideally suited for solving the latter SOC control problem for HCCI engines at middle and high engine loads.

### BRIEF DESCRIPTION OF THE DRAWINGS

The above and other objects, features and advantages of the present invention will be more apparent from the following detailed description taken in conjunction with the accompanying drawings, in which:

FIG. 1 is a block diagram of the major units of a turbo-cool engine;

FIG. 2 is a flow diagram of the turbo-cooler unit with the turbo-cooler valve;

FIG. 3 is an alternative version of FIG. 1 representing a turbo-cool spark ignition (SI) engine;

FIG. 4 is a diagram comparing the charge-air temperature vs. the charge-air pressure (or the charge-air pressure before throttle for the case of spark injection (SI) engines) for three turbocharged engines: a turbocharged engine with no charge-air cooling (CAC), a turbocharged engine with CAC, and a turbocharged engine with turbo-cooling (Turbo-Cool CAC);

FIG. 5 illustrates the experimental procedure of varying the settings of throttle butterfly and turbo-cooler valve of spark ignition (SI) engines under the constraint of constant charge-air pressure to determine the optimum combined throttle butterfly and turbo-cooler settings;

FIG. 6 illustrates three cases of turbocharger selection on the spark injection (SI) engine operation at maximum engine load;

FIG. 7 is a diagram showing the maximum charge-air pressure vs. compression ratio based on the knock limits consideration for three turbocharged engines: turbocharged engine with no charge-air cooling (CAC), turbocharged engine with CAC, and turbocharged engine with Turbo-Cool CAC; and

FIG. 8 illustrates the experimental procedure of varying the settings of fuel rate and turbo-cooler valve of diesel engine under the constraint of constant charge-air pressure to determine the optimum combined fuel injection means and throttle butterfly settings.

### DETAILED DESCRIPTION OF PREFERRED EMBODIMENTS

Hereinafter, preferred embodiments of the present invention will be described with reference to the accompanying drawings. In the following description of the present invention, a detailed description of known functions and configurations incorporated herein will be omitted to keep the subject matter of the present invention clear.

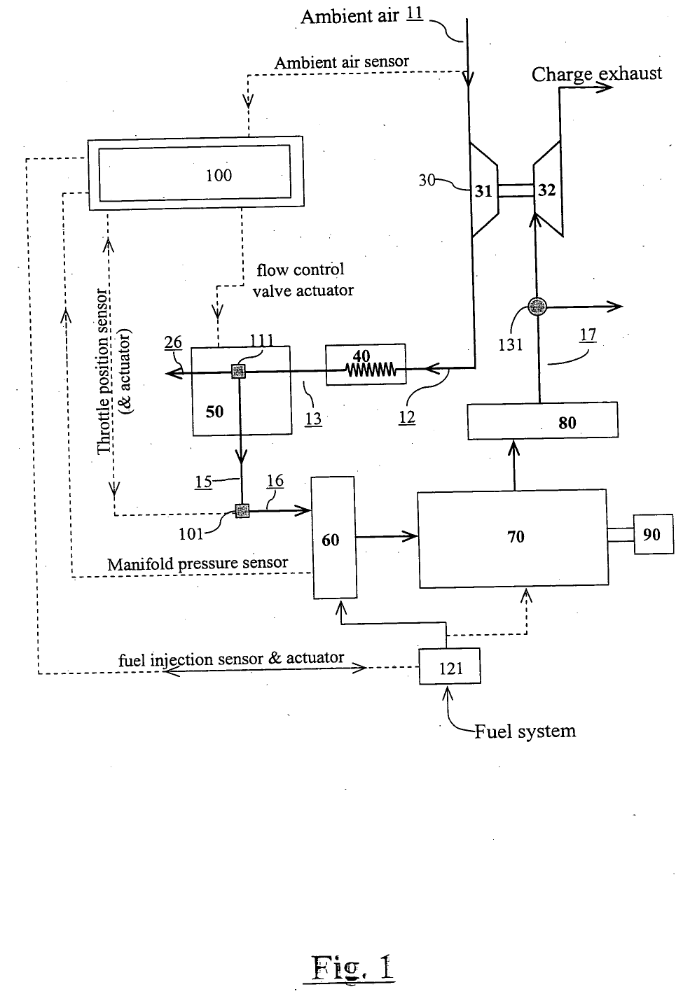

A supercharged intercooled engine in accordance with turbo-cooling principle is depicted in FIG. 1. An ambient air stream 11, characterized by temperature T₀ and pressure P₀, enters the compressor 31 of a turbocharger unit 30. Therein air stream 11 is pressurized such that its temperature and pressure are increased to T₁ and P₁, exiting compressor 31 as air stream 12. Air stream 12 is in communication with an intercooler 40. Intercooler 40 is a heat exchanger, wherein air stream 12 is cooled by an ambient coolant (not shown) to a temperature T₂, exiting as air stream 13. The pressure of air stream 13, P₂, is only slightly lower than P₁ as a result of pressure head loss in intercooler 40.

Air stream 13 enters a turbo-cooler 50, wherein air stream 13 is divided into two paths: air stream of the first path exiting as charge-air 15, and air stream of the second path exiting as air discharge stream 26.

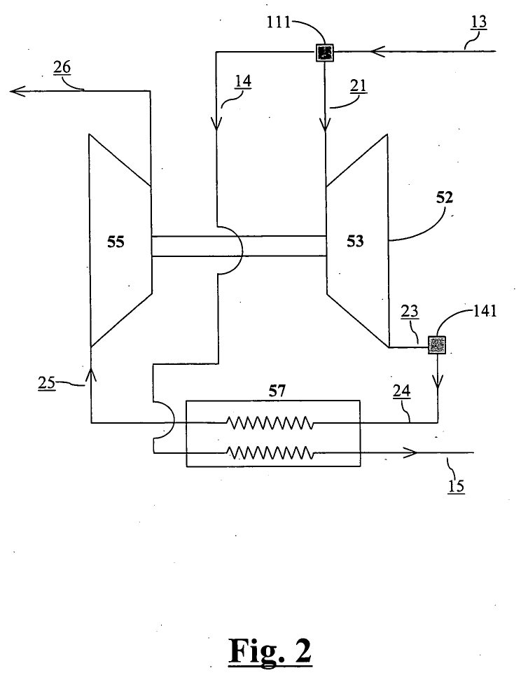

The details of turbo-cooler are depicted in FIG. 2. Air stream 13 communicates with a turbo-cooler valve 111. Turbo-cooler valve 111, in a preferred embodiment, is a flow control valve that distributes a portion of air stream 13 into a second air stream 21. The remainder of air stream 13, hereafter designated as a first air stream 14. The first air stream 14 is conveyed to a heat exchanger 57.

The second air stream 21 is in communication with the inlet of a turbine expander 53 of an expander/suction-compressor unit 52. Air stream 21 undergoes an expansion cooling process in turbine expander 53 from P₂ to P₃. The exit pressure P₃ from expander 53 is determined by the power balance between turbine expander 53 and suction compressor 55 of the expander/suction-compressor unit 52. The energy expended in operating turbine expander 53 reduces the temperature of second air stream 21 from T₂ to T₃. This air stream leaving turbine expander 53 at T₃ (denoted by reference numeral 23) is thereupon passed through a water separator 141 (now denoted by reference numeral 24) and then conveyed to the heat exchanger 57, wherein heat transfer takes place from first air stream of charge-air to the second air stream. The second air stream exits the heat exchanger 57 at a temperature T₄ and a pressure P₄, which is only slightly lowered than P₃, as air stream 25. The first air stream of charge-air exits the heat exchanger 57, as air stream 15, at a pressure P₅, which is only slightly lower than P₂, and at a temperature T₅. (In the case diesel engines, first air stream exiting heat exchanger 57 will be denoted as air stream 16 at T₆ and P₆, see explanation below.)

The heat exchange 57 may be either a cross flow heat exchanger or a rotary heat exchanger. For the rotary heat exchanger, the rotating matrix of the heat exchanger is in contact alternatively with colder second air stream (24 to 25) and with warmer first air stream (14 to 15) potentially making the water separator 141 unnecessary.

The conditioning of air intake, as performed by the turbo-cooler may be carried out by other types of conditioning apparatus and methods. The methods for conditioning of air intake may include the use of a refrigeration unit mechanically powered by a crankshaft of the engine; and may include the use of an injector of water or liquids having a low boiling temperature.

The second air stream 25 is in communication with the inlet of a suction-compressor 55 of the expander/suction-compressor unit 52. Air stream 25 undergoes compression in compressor 55, powered by expander 53, from pressure P₄, which is less than atmospheric, to P₇, which is equal to the atmospheric P₀, discharging as air stream 26. The same compression process of compressor 55 increases the temperature of second air stream from T₄ to T₇. Air discharging stream 26 into atmosphere at T₇, which is moderately above ambient air temperature, represents only a moderate loss of available energy.

Referring back to FIG. 1, first air stream 15 is in communication with an engine charging system. First air stream 15 passes through, in the case of SI engine, a throttle butterfly 101 and enters the intake-manifold means 60 of internal combustion engine cylinder 70 as charge-air stream 16 at P₆ (also referred to as manifold absolute pressure) and T₆, which will be referred to hereafter as charge-air pressure and charge-air temperature, P_{C} and T_{C}. (An alternative practice of placing throttle butterfly before compressor 31 is also known.)

In the case of diesel engines, there is no throttle butterfly. The first air stream exiting from heat exchanger 57 is the charge-air, which enters directly the inlet-manifold means 60 of internal combustion engine cylinder 70 as charge-air stream 16 (i.e., for diesel engines, P₅=P₆=P_{C} and T₅=T₆=T_{C}).

Exiting from engine 70, the air stream of charge exhaust (now designated by reference numeral 17) passes through exhaust manifold means 80 to enter turbine 32 of turbocharger 30. A wastegate valve 131 for boost-pressure safety-relief is placed between exhaust manifold means 80 and turbine 32. Turbine 32 powers the compressor 31.

A fuel injection means 121 is located at the inlet manifold 60 for port injection for SI engines. Alternatively, fuel injection means 121 is located at engine cylinder 70 for diesel engines. For direct injection SI engines, two fuel injection means (121) are used. One fuel injection means is located at engine cylinder 70 and the other located at inlet manifold 60, the former being used during heterogeneous-charge mode and the latter during homogeneous-charge mode operation.

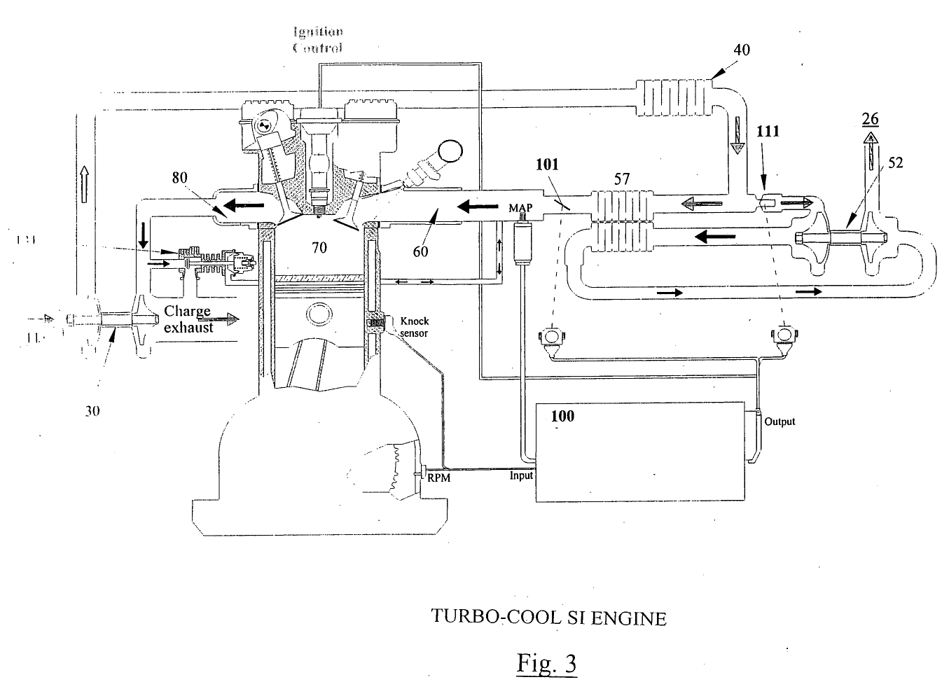

A more realistic, but still schematic, drawing of one version of FIG. 1 is given as FIG. 3, which depicts the specific version of a turbo-cool spark ignition engine highlighting the essence of turbo-cool as the simultaneous controlling of load-and-speed and conditioning of intake air temperature through the combined application of the throttle butterfly, primarily for load-and-speed control, and the turbo-cooler valve, primarily for intake air conditioning.

Referring to FIG. 1, an engine 70 starts its operation at idling setting. With gradually increasing load control setting (throttle butterfly 101 settings for SI engines, or fuel injection settings for diesel engines), the power boosting effect of the turbocharger is beginning to take effect at some point in the low end of speed range and load range. After the turbo-charging boost takes effect, the load control setting continues to be raised beyond and over that of the normal setting for a given load. Such continued rise in the load control setting would have been accompanied by excessive enthalpy in charge exhaust (17) (which is available to drive the turbine 32) over what is needed for maintaining the given load at steady-state operation. To absorb the excess enthalpy, the turbo-cooler valve 111 opens to admit air flow through the second air stream path, resulting in a mass flow rate through compressor 31 greater than the required charge-air mass flow rate. The opening of turbo-cooler valve 111 activates the operation of the turbo-cooler 50 to produce charge-air 16 at low temperature. The engine operation undergoes through a transient operation stage and then approaches a steady-state operation.

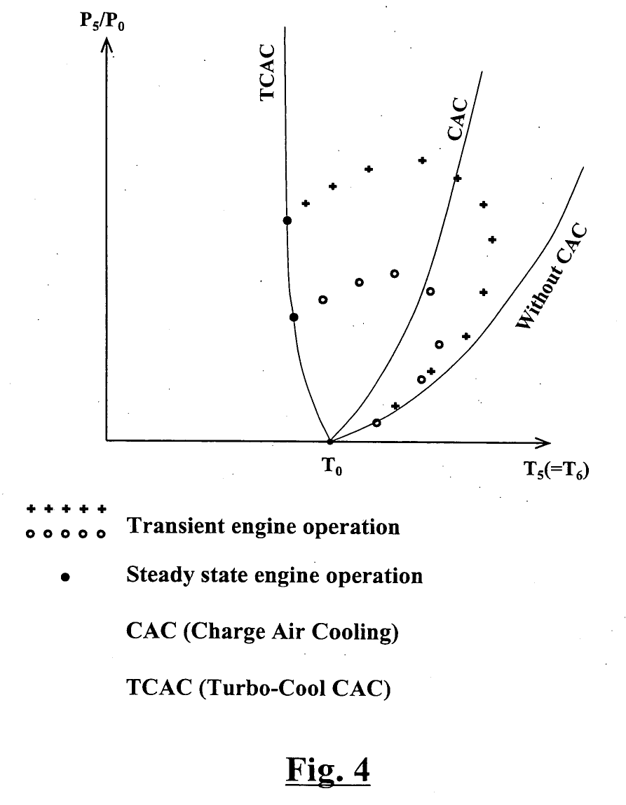

The final steady-state engine operation with the desirable charge-air temperature and pressure (referred to as turbocharged engine with Turbo-Cool Charge-Air Cooling (TCAC)) is compared with the steady-state operation of a turbocharged engine with Charge-Air Cooling (CAC) and the steady-state operation of a turbocharged engine (without CAC) in FIG. 4. The construction of steady-state engine operating T_{C} (T₆) vs. operating P_{C} (P₆) is explained below. A schematic representation of transient engine operation in responding to a throttle butterfly opening (for SI engines) or a fuel injector actuation (for diesel engines) is also shown in FIG. 4 in terms of transient charge-air temperature and charge-air pressure approaching the steady-state T_{C} and P_{C}.

The optimum steady-state operating T_{C} (T₆) vs. operating P_{C} (P₆) relation at a given speed may be dependent on the ambient humidity, temperature and pressure. At given ambient condition, the optimum operating T_{C} (T₆) vs. operating P_{C} (P₆) relation is determined on the basis of the “optimization” of thermal efficiency under the constraint of constant charge-air pressure.

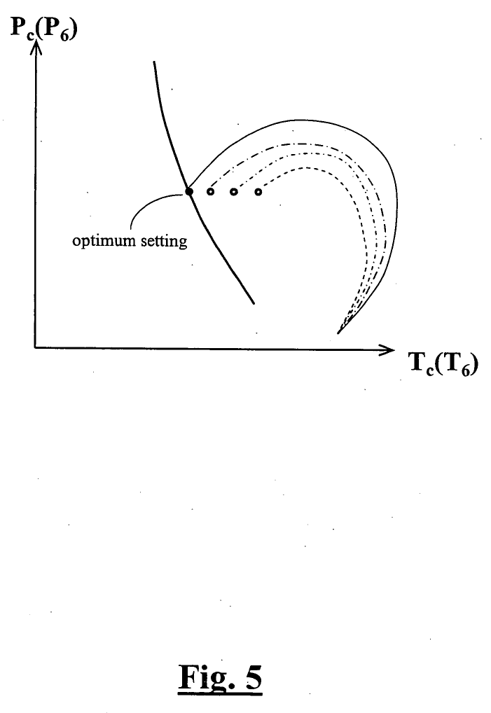

Considering SI engines first, the optimization is described as follows. Testing data of engine steady-state operations are shown schematically in FIG. 5 at various specific combination settings of throttle butterfly 101 and turbo-cooler valve 111 that produce the charge-air pressure value chosen as the constraint. Each point represents the steady-state charge air condition T_{C} and P_{C} corresponding to a specific throttle (turbo-cooler) valve setting combination under the constant charge-air pressure P_{C} constraint. Each line represents the charge-air conditions during the transient engine operation approaching the steady-state operation. Starting with the one farthest from the one corresponding to the optimum setting, each line moving closer to the optimum-setting line, representing a wider opening of the throttle plate setting. Thermal efficiency is measured at each specific throttle butterfly/turbo-cooler valve combination setting corresponding to a specific T_{C} at the given charge-air pressure, P_{C}. Once a particular throttle butterfly/turbo-cooler valve combination setting is determined to provide an optimum performance, the particular setting is considered to be an “optimum” setting. There are three possibilities for determining the “optimum” performance: thermal efficiency reaches maximum at the optimum setting; charge-air temperature reaches a minimum at a maximum open position of the turbo-cooler valve 111 (further valve opening leads to increasing charge-air temperature); charge-air temperature reaches a minimum operating under given ambient temperature and humidity (further temperature reduction leads to frosting in the heat exchanger). These optimum settings become the basis for a designing (mechanical) mechanism for the two-degree-of-freedom load control. Alternatively, data for optimum settings are stored in maps (turbo-cooler valve position vs. throttle butterfly position and engine speed) and an electronic system of sensors, actuators, and electronic control unit (ECU) is developed for engine operation in accordance with the optimum setting maps. Each optimum setting provides engine with intake air in a “sweet spot” of charge-air temperature and pressure for optimum engine operation at given steady-state speed and load.

It should be noted that the throttle butterfly opening of these optimum settings of the throttle butterfly/turbo-cooler valve combination corresponds to higher than the normal opening of throttle butterfly at a given relative load condition. This amounts to a reduction in using throttling effect in the load control of SI engines. Such reduction in reliance of throttling for load control has important benefit for the part-load thermal efficiency of SI engines. This is one reason that a much greater improvement in overall thermal efficiency is expected for SI engines, narrowing the fuel economy gap between SI engines and diesel engines.

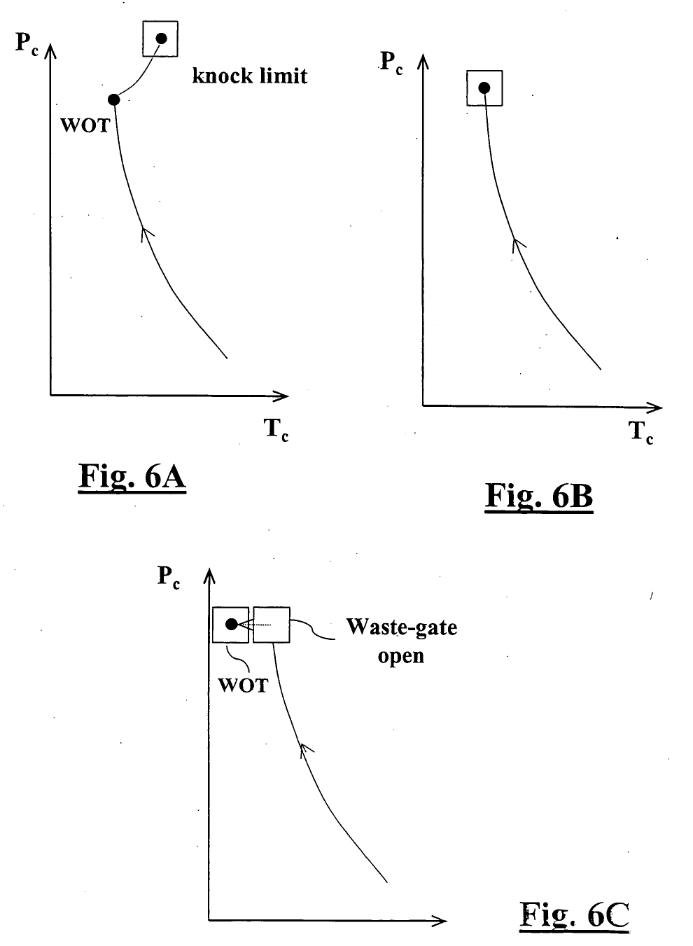

The selection (matching) of a specific turbocharger for the base piston engine affects whether, at a given engine speed, the wide open throttle (WOT) setting is reached before the knock limit, or the WOT setting coincides with the knock limit, or the knock limit is reached before the WOT setting. These three possibilities are represented in terms of steady-state operating T_{C} (T₆) vs. operating P_{C} (P₆) in FIG. 6A, FIG. 6B, and FIG. 6C respectively. FIG. 6A shows that after reaching the WOT setting the further increase in charge-air pressure, and load, is brought about by closing the turbo-cooler valve 111, leading to a slight increase in charge-air temperature before reaching the knock limit. FIG. 6B shows engine operation reaches the WOT setting and knock limit simultaneously. FIG. 6C shows that, once knock limit is reached, the wastegate valve opens with continuously increasing throttle butterfly opening toward WOT, keeping charge-air pressure constant. Under these conditions turbo-cooler valve 111 may be set to open wider for second air stream, resulting in a desirable change in charge-air temperature.

As shown in FIG. 4, the charge-air temperature of a TCAC engine of the present invention operating near maximum load is lower than that of a turbocharged engine (with no CAC) or a turbocharged engine with CAC. This enables the design of engine operating with considerably higher maximum charge-air pressure, which is basically that of knock-limited charge-air pressure reduced with a safety margin.

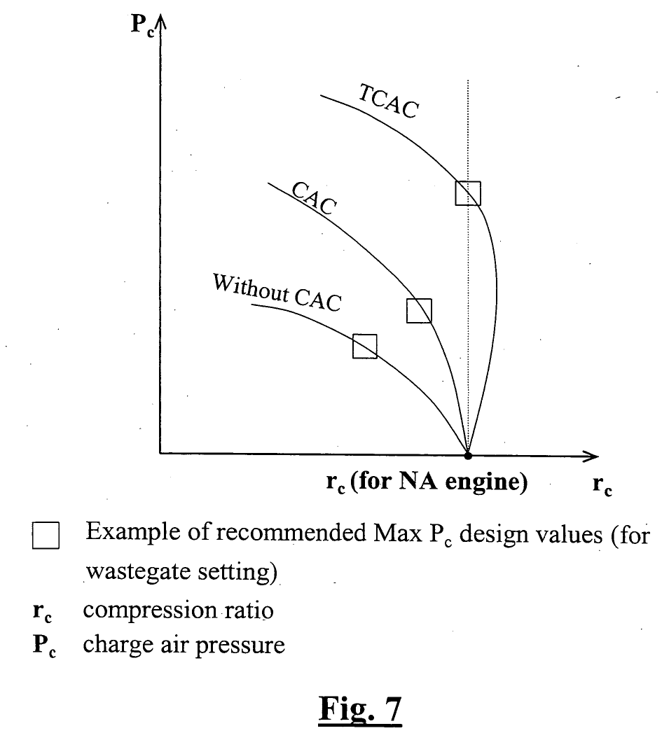

In FIG. 7, recommended design values for maximum P_{C} (P₆) are shown schematically vs. engine compression ratio r_{C}, with maximum brake torque (MBT) timing and the same octane-rating fuel for all three turbo-charged engines (without CAC, CAC, and TCAC). Of special interest for the after-market application of fitting turbo-charging to a naturally-aspirated engine is the possibility of fitting a turbo-cool turbo-charging system without the requirement of lowering the original engine compression ratio or any serious compromise in spark-timing retard from MBT timing, thereby reducing the cost of such after-market project considerably.

A more than 30% improvement in overall thermal efficiency for SI engines is expected as a result of the following simultaneous-benefits. Referring to FIG. 5, each steady-state data point closer toward the optimum-setting steady-state data point brings about all three following benefits:
1. Lower Friction Loss—Absolute friction loss is a function of rpm, and remains constant as power increases. Therefore, the relative value of this loss decreases as power increases;
2. Lower Throttle Loss under part-load operations—Throttle-butterfly opening at a typical optimum combined-setting is wider than the normal opening at a given part-load. Therefore, throttling loss at part-load is less;
3. Lower Exhaust Loss due to the conditioning of charge-air through turbo-cooling—Air is conditioned resulting in lowered entropy for the charge-air.

Consequently, temperature of charge exhaust, as seen in a T-S diagram, will be lowered as a result of the lower entropy of the charge-air.

The same “conditioning of charge-air through turbo-cooling” raises the (knock-limited) maximum charge-air pressure to be significantly higher than an existing turbocharged SI engine. An improvement of 50% to 100% in power density over naturally-aspirated SI engines is projected.

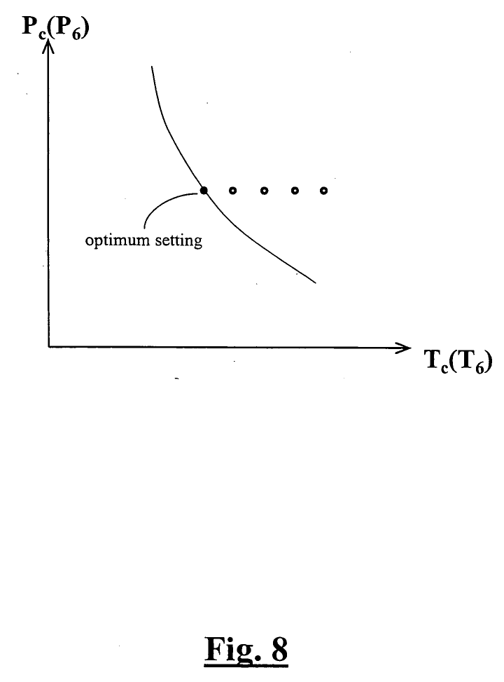

Testing, similar to that for turbo-cool SI engine, is conducted for turbo-cool diesel engine. The optimum steady-state operating T_{C} (T₆) vs. operating P_{C} (P₆) relation at a given speed may be dependent on the ambient humidity, temperature and pressure. At given ambient condition, the optimum operating T_{C} (T₆) vs. operating P_{C} (P₆) relation is determined on the basis of the “optimization” of thermal efficiency under the constraint of constant charge-air pressure. Testing data of engine steady-state operations are shown schematically in FIG. 8 at various specific combination settings of fuel system 121 and turbo-cooler valve 111 that produce the charge-air pressure value chosen as the constraint. Each point represents the steady-state charge air condition T_{C} and P_{C} corresponding to a specific fuel-rate (turbo-cooler) valve setting combination under the constant charge-air pressure P_{C} constraint. Starting with the one farthest from the optimum setting, each data point moving closer to the optimum-setting indicates a higher fuel-rate setting.

Thermal efficiency is measured at each specific fuel system/turbo-cooler valve setting combination corresponding to a specific T_{C} at the given charge-air pressure, P_{C}. Once a particular fuel system/turbo-cooler valve combination setting is determined to provide an optimum performance, the particular setting is considered to be an “optimum” setting. There are three possibilities for the “optimum” performance: thermal efficiency reaches maximum at the setting; charge-air temperature reaches a minimum at a maximum open position of the turbo-cooler valve 111 (further valve opening leads to increasing charge-air temperature); charge-air temperature reaches a minimum operating under given ambient temperature and humidity (further temperature reduction leads to frosting in the heat exchanger). These optimum settings become the basis for designing (mechanical) mechanism for the two-degree-of-freedom load control. Alternatively, data for optimum settings are stored in maps (turbo-cooler valve position vs. fuel injection rate and engine speed) and an electronic system of sensors, actuators, and electronic control unit (ECU) is developed for engine operation in accordance with the optimum setting maps. Each optimum setting provides engine with intake air in a “sweet spot” of charge-air temperature and pressure for optimum engine operation at given steady-state speed and load.

A more than 10% improvement in thermal efficiency for diesel engines is expected as a result of the following simultaneous-benefits:
1. Lower Friction Loss;
2. Lower Exhaust Loss due to the conditioning of charge-air through turbo-cooling.

Although a diesel engine having no throttle cannot benefit from “reduction in throttling loss,” it does benefit from a similar wider-setting of load control as a SI engine (in the form of fuel injection rate instead of throttle butterfly). At optimized combined-settings of fuel injection rate and turbo-cooler valve, the fuel rate is higher than the normal fuel-rate setting at the same relative load condition (see FIG. 8). This remains the case at full-load, resulting in higher power rating. Maximum fuel rate can be significantly higher than an existing diesel engine subjected to the same limit in maximum exhaust temperature. An improvement of more than 20% in power density over existing turbocharged diesels is expected.

Data maps for optimum settings for the direct-injection SI engine are generated for its heterogeneous-charge operation mode in testing similar to the diesel engine and for its homogeneous-charge operation mode in testing similar to that for the SI engine.

Referring back to FIG. 1 again, an engine control module 100 (which may be a part of a power-train controller) receives input signals from an ambient air sensor, an intake manifold pressure sensor, an exhaust charge temperature & oxygen sensor, throttle position sensor, fuel injection system sensor, engine knock sensor (engine cylinder pressure sensor for diesel engines), engine speed sensor, and driver command signal. Based on these inputs, control module 100 then sends command signals, in accordance with the maps of the optimum settings as determined in the above described methods, to a throttle butterfly switch (in the case of throttle-by-wire that driver command does not directly control throttle butterfly position), fuel injection actuator, engine valve timing and lift control (may be a continuously variable intake valve in timing and lift), turbo-cooler valve actuator, and electronic spark timing.

The ability of simultaneously controlling engine load/speed and intake air temperature at optimal value over a broad range of loads and speeds has an additional application. One of the most promising engine technologies that has emerged over the past few years is called the HCCI (homogeneous charge compression ignition) engine. The combustion process for the HCCI engine is fundamentally different from SI or diesel combustion in the form of spontaneous flameless combustion. The low temperature spontaneous flameless combustion produces very low NOx and particulate matter (PM) emissions combined with high, diesel-like, efficiency under ideal conditions. This combination of low emissions and high efficiency explains the excitement generated by the prospect of HCCI. Currently, the promise and the excitement are tempered only by the considerable challenges HCCI faces. The most crucial ones among them is the control of start-of-combustion (SOC) due to the “spontaneous” nature of combustion-ignition.

Without a spark plug as in the Otto, or a fuel injector as in the Diesel, HCCI SOC depends on (i) charge mixture reactivity, and (ii) the time-temperature history of the homogeneous charge mixture (i.e., HCCI SOC is a functional of time-temperature history). The objective of SOC control is to prepare the charge of a HCCI engine at a “tipping point” for spontaneous combustion at optimal SOC crank angle, producing an ideal HCCI combustion. Methods (such as EGR and ignition-assistance) are available for promoting HCCI ignition (making SOC earlier) at low engine loads. It is more difficult to delay HCCI ignition (which becomes necessary at middle and high engine loads under turbocharging conditions) to produce ideal HCCI combustion at high loads. Methods, including conditioning of intake charge that are used in laboratory experiments for controlling SOC, are impractical for mobile applications. Turbo-Cool is a technology for conditioning of intake charge for mobile applications, and is ideally suited for solving the latter SOC control problem for HCCI engines at middle and high engine loads. Testing is conducted for the turbo-cool HCCI engine to develop an engine management mapping-algorithm, in which inputs of load requirement signal, intake manifold pressure, engine speed, knock sensor signal, fuel air ratio (oxygen sensor), temperature sensor signals, and ambient conditions are processed to generate outputs of ignition timing, fuel injection rate and timing, throttle butterfly opening, valve timing and lift, and turbo-cooler valve opening wherein the turbo-cooler valve opening is selected for conditioning of intake air for achieving the objective of improving thermal efficiency and producing start-of-combustion at correct crank-angle at middle and high engine loads resulting in maximum brake torque.

While the invention has been shown and described with reference to certain preferred embodiments thereof, it will be understood by those skilled in the art that various changes in form and details may be made therein without departing form the spirit and scope of the invention as defined in the appended claims.

1. A turbocharged intercooled internal combustion engine comprising:
a first operation control unit for load and speed control;
a second operation control unit, for conditioning intake air temperature; and
an operation control means for controlling start-of-combustion; wherein the first operation control unit and the second operation control unit simultaneously control load-and-speed and intake air conditioning.

2. An engine as in claim 1 wherein the second operation control unit is a turbo-cooler, and comprises:
a turbo-cooler valve for distributing turbocharger-compressed and intercooled airflow into a charge-airflow and a coolant airflow;
an expander for expanding and cooling the coolant airflow to a pressure below ambient pressure;
a heat transfer means in which the expanded and cooled coolant airflow absorbs heat from the charge-airflow; and
a suction compressor for compressing the coolant airflow exiting from said heat transfer means to ambient pressure and discharging the coolant airflow to the atmosphere.

3. An engine as in claim 2, wherein said internal combustion engine is a homogeneous charge spark ignition engine, and wherein:
said first operation control unit is a throttle butterfly;
said start of combustion is controlled by a spark plug; and
said conditioning of intake air improves thermal efficiency and avoids knock.

4. An engine as in claim 2, wherein said internal combustion engine is a diesel (heterogeneous charge compression ignition) engine, and wherein:
said first operation control unit is a fuel injection system;
said start of combustion is controlled by the fuel injection timing; and
said conditioning of intake air improves thermal efficiency and reduces thermal loading at high engine loads.

5. An engine as in claim 2, wherein said internal combustion engine is a homogeneous charge compression ignition (HCCI) engine, and wherein:
said first operation control unit comprises a fuel injection system and a throttle butterfly; and
said start of combustion is controlled by a means to promote ignition at low loads, and said second operation control unit prevents premature ignition at high engine loads.

6. A method for operating an internal combustion engine, comprising simultaneously controlling of load-and-speed and conditioning of intake air temperature.

7. The method as in claim 6, wherein said internal combustion engine is a turbocharged intercooled internal combustion engine.

8. The method as in claim 7, wherein the conditioning air intake temperature step is performed by a turbo-cooler.

9. The method as in claim 6, wherein the conditioning of intake air temperature step is performed by a refrigeration unit mechanically powered by a crankshaft of the engine.

10. The method as in claim 6, wherein the conditioning of intake air temperature step is performed by an injector of water or liquids having a low boiling temperature.

11. The method as in claim 8, wherein said internal combustion engine is a homogeneous charge spark ignition engine.

12. The method as in claim 11, wherein the load-and-speed control step is performed by a throttle butterfly and the intake air temperature conditioning step is performed by a turbo-cooler valve that distributes the turbocharger-compressed and intercooled airflow into charge-airflow and coolant airflow through the turbo-cooler.

13. The method as in claim 11, wherein the load-and-speed control step is performed by a continuously variable intake valve in timing and lift, and the intake air temperature conditioning step is performed by a turbo-cooler valve that distributes the turbocharger-compressed and intercooled airflow into charge-airflow and coolant airflow through the turbo-cooler.

14. The method as in claim 12 wherein setting of the turbo-cooler valve is a function of the throttle butterfly setting, intake air pressure, engine speed, and ambient temperature, pressure and humidity; and wherein said function is established for achieving optimal thermal efficiency at a given intake air pressure.

15. The method as in claim 8 wherein said internal combustion engine is a diesel (heterogeneous charge compression ignition) engine.

16. The method as in claim 15 wherein the load-and-speed control step is performed by fuel-rate control and the intake air temperature conditioning step is performed by a turbo-cooler valve that distributes the turbocharger-compressed and intercooled airflow into charge-airflow and coolant airflow through the turbo-cooler.

17. The method as in claim 16, wherein setting of the turbo-cooler valve is a function of the fuel rate control setting, intake air pressure, engine speed, and ambient temperature, pressure and humidity; and wherein the function is established for achieving optimal thermal efficiency at a given intake air pressure.

18. The method as in claim 8, wherein said engine is a direct-injection spark ignition engine.

19. The method as in claim 8, wherein said engine is a homogeneous charge compression ignition (HCCI) engine.

20. The method as in claim 19 wherein the load-and speed control step is performed by a fuel-rate control and the intake air temperature conditioning step is performed by a turbo-cooler valve that distributes the turbocharger-compressed and intercooled airflow into charge-airflow and coolant airflow through the turbo-cooler.

21. The method as in claim 19 wherein the load-and speed control step is a fuel-rate control and a throttle butterfly, and the intake air temperature conditioning step is performed by a turbo-cooler valve that distributes the turbocharger-compressed and intercooled airflow into charge-airflow and coolant airflow through the turbo-cooler.

22. The method as in claim 20 wherein the setting of said turbo-cooler valve is a function of the fuel rate control setting, intake air pressure, engine speed, and ambient temperature, pressure and humidity; and wherein the function is established for conditioning intake air temperature at a given intake air pressure to produce start-of-combustion at a correct crank-angle resulting in maximum brake torque.

23. The method as in claim 21 wherein the setting of said turbo-cooler valve is a function of the fuel rate control setting, the throttle butterfly setting, intake air pressure, engine speed, and ambient temperature, pressure and humidity; and wherein the function is established for conditioning intake air temperature at a given intake air pressure to produce start-of-combustion at correct crank-angle resulting in maximum brake torque.

24. An engine management method, incorporating an engine management mapping-algorithm comprising the steps of:
sensing and inputting engine management data including a load requirement signal, an intake manifold pressure, an engine speed, a knock sensor signal, a fuel air ratio, temperature sensor signals, and ambient conditions; and
processing said data to generate outputs of an ignition timing, a fuel injection rate and timing, a throttle butterfly opening, a valve timing and lift, and a turbo-cooler valve opening, wherein the turbo-cooler valve opening is selected for conditioning of intake air so as to improve thermal efficiency and avoid knock in application to homogeneous charge spark ignition engines; improve thermal efficiency and reduce thermal loadings at high engine loads in application to heterogeneous charge compression ignition engines leading to improved rated power; and improve thermal efficiency and produce start-of-combustion at a correct crank-angle at middle and high engine loads resulting in maximum brake torque in application to homogeneous charge compression ignition engines.
